(19) United States
(12) Patent Application Publication
(10) Pub. No.: US 2014/0097767 A1
(43) Pub. Date: Apr. 10, 2014

(54) REMOTELY CONTROLLED SMART LIGHTING SYSTEM

(71) Applicant: FOXSEMICON INTEGRATED TECHNOLOGY, INC., (US)

(72) Inventors: KUAN-HONG HSIEH, Miaoli (TW); TE-SHENG CHEN, Miaoli (TW)

(73) Assignee: FOXSEMICON INTEGRATED TECHNOLOGY, INC., Chu-Nan (TW)

(21) Appl. No.: 13/773,794

(22) Filed: Feb. 22, 2013

(30) Foreign Application Priority Data
Oct. 8, 2012 (TW) 101137118

(51) Int. Cl. H05B 37/02

(52) U.S. Cl. CPC H05B 37/02
USPC 315/291

(57) ABSTRACT

The disclosure provides a smart lighting system. The smart lighting system includes a lighting apparatus, a controller, and a remote control. The lighting apparatus is coupled to the controller and a power supply. The controller is connected to the remote control via a communication interface. The controller includes a user identification device (UID), a encryption system, and a dimmer. Via the encryption system, the UID is adapted to authenticate the signals transmitted from the remote control, and the dimmer modifies electrical currents from the power supply for the lighting apparatus according to the signal. The brightness of the lighting apparatus is thus modulated by the remote control.

### BACKGROUND

1. Technical Field

The disclosure is related to a smart lighting system, and particularly to a smart lighting system operated by a remote control to adjust its brightness.

2. Description of Related Art

Efficient lighting is replacing old fashioned energy-hungry incandescent light bulbs and halogen spotlights. Lighting devices with light emitting diodes (LEDs) are used in many common applications. To adjust brightness, dimmers for the LEDs are required to provide a range of currents for driving the LEDs.

Lighting apparatus in living rooms, bedrooms, and dining rooms have different lighting requirements. The lighting requirements may be affected by location of the house, incident angles of sunlight, and decoration style. However, known dimmers of related art available on the market, are incompatible amongst different manufacturers and are incapable of meeting all the different lighting requirements for the lighting apparatuses in different areas of the house. Multi-purpose dimmers capable of meeting various requirements for lighting and reducing energy consumptions of the lighting apparatuses are therefore desirable.

### BRIEF DESCRIPTION OF THE DRAWINGS

The components in the drawing are not necessarily drawn to scale, the emphasis instead being placed upon clearly illustrating the principles of a smart lighting system.

FIG. 1 is a block diagram illustrating the lighting system controlled by smart remote of the present application.

### DETAILED DESCRIPTION

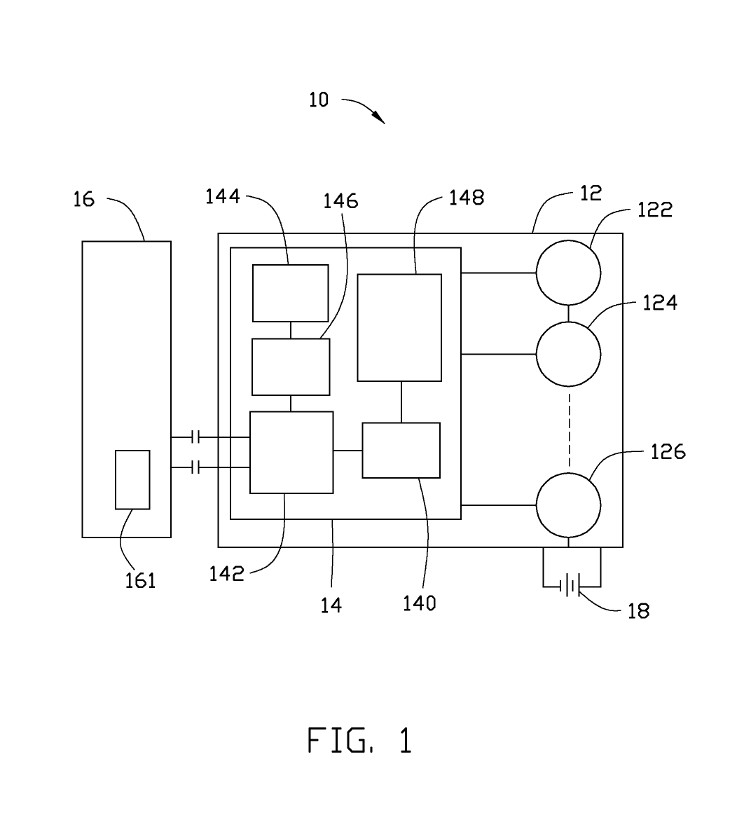

The disclosure is described with reference to FIG 1.

FIG. 1 shows a schematic diagram of a smart lighting system 10 according to a preferred embodiment of the disclosure. The smart lighting system 10 includes a lighting apparatus 12, a controller 14, and a remote control 16. The lighting apparatus 12 may be a device capable of generating light directly or indirectly, such as a light bulb 122, a light tube 124, or a socket 126. For example, the light bulb 122 and the light tube 124 are devices emitting light directly when coupled to a power source. The socket 126 is an intermediate device installed between a light-emitting device and a power supply; so that the socket 126 may be regarded generating light indirectly or simply enabling the emission of light. The lighting apparatus 12 is coupled to the controller 14 and a power supply 18. The power supply 18 connects to the lighting apparatus 12 by power line communication (PLC) such as a power cord.

The controller 14 is installed inside the lighting apparatus 12. The controller 14 includes a communication interface 142, a user identification device (UID) 144, a encryption system 146, and a dimmer 148. The remote control 16 is adapted to communicate with the communication interface 142 via a signal communication device 161 of the remote control 16. The remote control 16 is adapted to generate and transmit signals including double tone multi-frequency (DTMF) signals, frequency shift keying (FSK) signals, or orthogonal frequency division multiplexing (OFDM) signals. The remote control 16 may be a remote, a smart phone, a tablet, or other hand-held device. The signal communication device 161 may be an infrared (IR) transmitter/receiver, a BLUETOOTH device, a WiFi device, a voice control device that passes the signals through a telephone wire, a wireless router, a home network, an internet server, or a cloud server.

When a user operates the remote control 16 and makes the remote control 16 generate and transmit signals to the communication interface 142 of the controller 14. The encryption system 146 encrypts and. decrypts the signals between the remote control 16 and the controller 14. The aforementioned signals between the communication interface 142 and the remote control 16 are further transmitted to the UID 144. The UID 144 is adapted to confirm an identification of a user who operates the remote control 16 and to authenticate the remote control 16.

Subject to the authentication described in the foregoing paragraph, when the communication interface 342 receives signals for adjusting brightness of the lighting apparatus 12, the dimmer 148 modulates electrical currents from the power supply 18 by a pulse-width modulation (PWM) technique to adjust brightness of the lighting apparatus 12 among several levels. The PWM is performed by a metal-oxide-semiconductor field-effect transistor (MOSFET) within the dimmer 148 that repeatedly turns on and off to provide an overall and stable current of a reference voltage for the lighting apparatus 12. By modulating the switch duty ratio of the MOSFET, the level of the current is modulated to adjust the brightness of the lighting apparatus 12.

An analog-to-digital converter (ADC) 140 is installed within the controller 14. The communication interface 142, the UID 144, the encryption system 146, and the dimmer 148 pass the signals through the ADC 140. The signals transmitted to the ADC may be analog inputs, reference voltage inputs, pulse inputs, or power inputs and are converted to digital outputs for further transmission within the controller 14. The digital signals are processed and stored in the controller 14 to make the controller 14 operate faster and therefore enhance the efficiency of the lighting apparatus 12.

It is to be understood, however, that even though numerous characteristics and advantages of the present embodiments have been set fourth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A smart lighting system comprising:
a remote control;
a controller connected to the remote control via a contntunication interface, the controller comprising a user identification device (UID), a encryption system and a dimmer; and
a lighting apparatus coupled between the controller and a power supply;
wherein the remote control is adapted to generate and transmit a signal between the remote control and the communication interface; the UID is adapted, to authenticate the signal via the encryption system; and the dimmer modulates electrical currents for the lighting apparatus according to the signal.

2. The smart lighting system of claim 1, wherein the lighting apparatus comprises a light bulb, a light tube, or a socket.

3. The smart, lighting system of claim 1, wherein the power supply is coupled to the light apparatus through a power cord and the controller is installed, inside the light apparatus.

4. The smart lighting system of claim 1, wherein the remote control is adapted to generate the signal comprising a dual-tone multi-frequency (DTMF) signal, a frequency shift keying (FSK) signal, or an orthogonal frequency division multiplexing (OFDM) signal.

5. The smart lighting system of claim 1, wherein the communication interface and the remote control communicate in dual-direction.

6. The smart lighting system of claim 1, wherein the UID is farther adapted, to authenticate the signal between the communication interface and the remote control by confirming a user's identification and authenticating the remote control.

7. The smart lighting system of claim 1, wherein the encryption system encrypts and decrypts the signal between the communication interface and the remote control.

8. The smart lighting system of claim 1, wherein the power supply provides the electrical currents for the lighting apparatus, and the dimmer modifies the electrical currents by a pulse-width modulation (PWM).

9. The smart lighting system of claim 1, wherein the controller further comprises an analog-to-digital converter (ADC) integrated in the controller.

10. The smart lighting system of claim 1, wherein remote control comprises a remote, a smart phone or a tablet; the remote control is adapted to communicate with the communication interface via a signal communication device on the remote control.

11. The smart lighting system of claim 10 wherein the signal communication device comprises an infrared (IR) transmitter/receiver, a BLUETOOH device, a Wi-Fi device, or a voice controller, and the signal communication device communicates with the controller via a telephone wire, a wireless router, a home network, a internet server, or a cloud server.
